(19) United States
(12) Patent Application Publication
(10) Pub. No.: US 2020/0314597 A1
(43) Pub. Date: Oct. 1, 2020

(54) MOVING BODY TRACKING DEVICE, MOVING BODY TRACKING METHOD, AND PROGRAM

(71) Applicant: NEC Corporation, Tokyo (JP)

(72) Inventors: Kenji ADACHI, Tokyo (JP); Kazuya Tsujimoto, Tokyo (JP); Ryuichiro Matsuoka, Tokyo (JP); Taichi Ohtsuji, Tokyo (JP); Toshiki Takeuchi, Tokyo (JP)

(73) Assignee: NEC Corporation, Tokyo (JP)

(21) Appl. No.: 16/828,540

(22) Filed: Mar. 24, 2020

(30) Foreign Application Priority Data
Mar. 28, 2019 (JP) 2019-062849

(51) Int. Cl. H04W 4/029; G06K 9/00; G06K 9/32; G06F 16/51

(52) U.S. Cl. CPC H04W 4/029; G06K 9/00288; G06K 2209/15; G06K 9/00838; G06F 16/51; G06K 9/325

(57) ABSTRACT

A moving body tracking system more efficiently identifies a moving body sending a particular radio wave, by including a memory that stores a set of instructions; and at least one processor configured to execute the set of instructions to identify, when a feature value of a radio wave received by a terminal is registered in a database, a moving body sending the radio wave, based on a plurality of images captured by the terminal and associated with the feature value of the radio wave.

This application is based upon and claims the benefit of priority from Japanese Patent Application No. 2019-062849, filed on Mar. 28, 2019, the disclosure of which is incorporated herein in its entirety by reference.

### TECHNICAL FIELD

The present invention relates to a moving body tracking device, a moving body tracking method, and a program.

### BACKGROUND ART

A movable object (moving body), such as a person holding a smartphone, a transport aircraft provided with communication equipment, or a vehicle on which a person belonging a portable terminal rides, may send a radio wave.

PTL 1 (Japanese Unexamined Patent Application Publication No. 2005-056000) discloses a system that monitors a traveling vehicle from which a radio wave of a cellular phone is sent, and recognizes whether a driver is calling on the cellular phone. The system acquires a vehicle body number of a vehicle driven by a driver calling on a cellular phone.

The technique described in PTL 1 includes monitoring, when receiving a radio wave sent from a cellular phone during a call, a vehicle driven by a driver calling on a cellular telephone, and capturing an image of a driver's seat when the vehicle reaches a predetermined image capturing region. Meanwhile, the technique does not disclose nor sufficiently consider identifying a vehicle being an emission source of a radio wave when there are a plurality of radio-wave emission sources as well as a plurality of vehicles captured in an image.

### SUMMARY

The present invention addresses an issue of more efficiently identifying a moving body sending a particular radio wave.

According to the present invention, there is provided a moving body tracking system including:

a memory that stores a set of instructions; and

at least one processor configured to execute the set of instructions to identify, when a feature value of a radio wave received by a terminal is registered in a database, a moving body sending the radio wave, based on a plurality of images captured by the terminal and associated with the feature value of the radio wave.

According to the present invention, there is provided a moving body tracking system including:

a memory that stores a set of instructions; and

at least one processor configured to execute the set of instructions to identify, when a feature value of a radio wave received by a terminal is registered in a database, a moving body sending the radio wave, based on a plurality of images captured by the terminal and associated with the feature value of the radio wave; wherein

the memory stores the feature value of the radio wave received by the terminal and the image captured by the terminal in association with each other, and

the processor registers, out of the radio waves sent from the moving body, the feature value of the radio wave whose feature value is unregistered in the database, and the feature value of the radio wave whose feature value is preliminarily registered in the database, in a watchlist in association with each other.

According to the present invention, there is provided a moving body tracking method including:

by an information processing device,

identifying, when a feature value of a radio wave received by a terminal is registered in a database, a moving body sending the radio wave, based on a plurality of images captured by the terminal and associated with the feature value of the radio wave.

According to the present invention, there is provided a program causing a computer to execute

processing of identifying, when a feature value of a radio wave received by a terminal is registered in a database, a moving body sending the radio wave, based on a plurality of images captured by the terminal and associated with the feature value of the radio wave.

### BRIEF DESCRIPTION OF THE DRAWINGS

FIG. 1 is one example of a function block diagram of a moving body tracking system according to the present example embodiment.

FIG. 2 is one example of a function block diagram of the moving body tracking system according to the present example embodiment.

FIG. 3 is a diagram representing a state in which an information acquisition terminal according to the present example embodiment is installed on a road.

FIG. 4 is one example of a function block diagram of a processing device according to the present example embodiment.

FIG. 5 is a diagram schematically illustrating one example of a structure of data processed by the moving body tracking system according to the present example embodiment.

FIG. 6 is a diagram schematically illustrating one example of a structure of data processed by the moving body tracking system according to the present example embodiment.

FIG. 7 is a diagram schematically illustrating one example of a structure of data processed by the moving body tracking system according to the present example embodiment.

FIG. 8 is a diagram illustrating one example of a concept of processing performed by the moving body tracking system according to the present example embodiment.

FIG. 9 is a diagram illustrating one example of a hardware configuration of the moving body tracking system according to the present example embodiment.

FIG. 10 is a flowchart illustrating one example of flow of processing performed by the moving body tracking system according to the present example embodiment.

FIG. 11 is a diagram schematically illustrating one example of a structure of data processed by the moving body tracking system according to the present example embodiment.

FIG. 12 is a flowchart illustrating one example of flow of processing performed by the moving body tracking system according to the present example embodiment.

FIG. 13 is one example of a function block diagram of the moving body tracking system according to the present example embodiment.

FIG. 14 is one example of a function block diagram of the moving body tracking system according to the present example embodiment.

FIG. 15 is a flowchart illustrating one example of flow of processing performed by the moving body tracking system according to the present example embodiment.

FIG. 16 is a flowchart illustrating one example of flow of processing performed by the moving body tracking system according to the present example embodiment.

FIG. 17 is one example of a function block diagram of the moving body tracking system according to the present example embodiment.

FIG. 18 is one example of a function block diagram of the information acquisition terminal according to the present example embodiment.

FIG. 19 is one example of a function block diagram of the processing device according to the present example embodiment.

FIG. 20 is a diagram schematically illustrating one example of a structure of data processed by the moving body tracking system according to the present example embodiment.

FIG. 21 is a flowchart illustrating one example of flow of processing performed by the moving body tracking system according to the present example embodiment.

FIG. 22 is a flowchart illustrating one example of flow of processing performed by the moving body tracking system according to the present example embodiment.

FIG. 23 is one example of a function block diagram of the moving body tracking system according to the present example embodiment.

### EXAMPLE EMBODIMENT

### First Example Embodiment

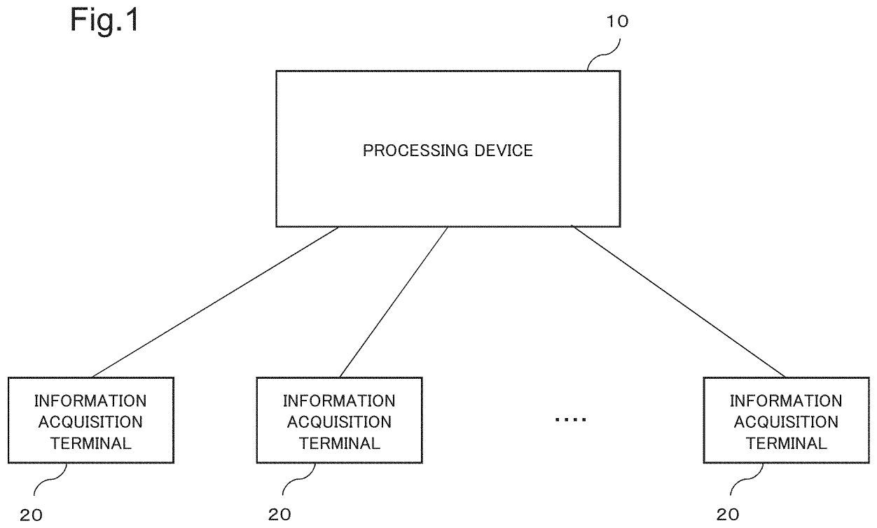

A first example embodiment of the present invention will be described. An overview of a moving body tracking system 100 according to the present example embodiment will be described by using a function block diagram of FIG. 1. A processing device 10 is communicable with one or more information acquisition terminals 20, and receives information acquired by the information acquisition terminal(s) 20.

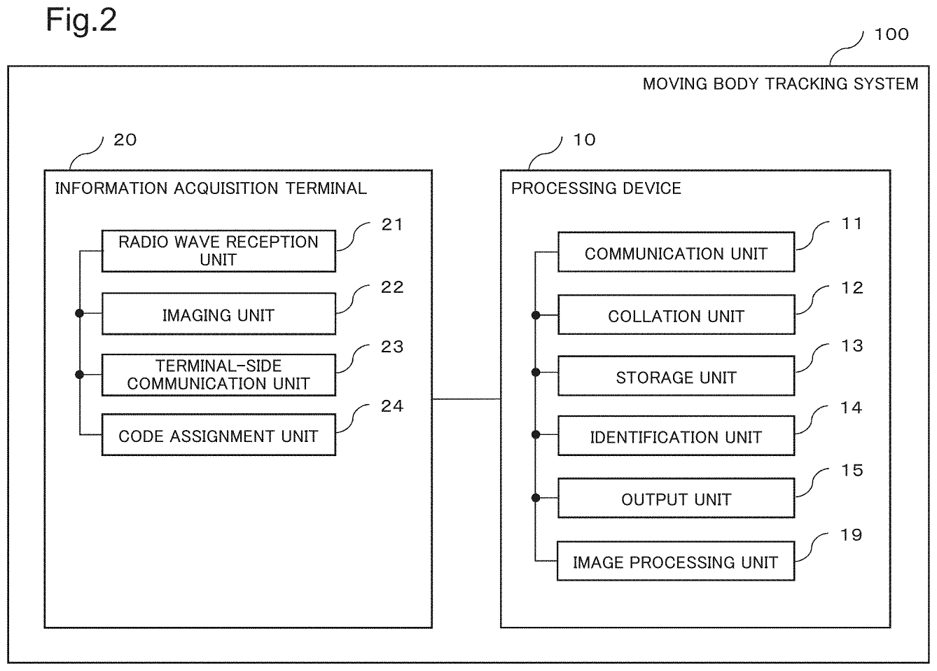

Next, the moving body tracking system 100 according to the present example embodiment will be described in detail by using a function block diagram of FIG. 2. The processing device 10 is a device accessible by an operator at a data center or the like, and includes a communication unit 11, a collation unit 12, a storage unit 13, an identification unit 14, an output unit 15, and an image processing unit 19. The processing device 10 acquires information received from the information acquisition terminal 20.

The information acquisition terminal 20 is a terminal installed along a road or the like, and includes a radio wave reception unit 21, an imaging unit 22, a terminal-side communication unit 23, and a code assignment unit 24. The processing device 10 and the information acquisition terminal 20 are connected with each other via a communication network such as the Internet, and are communicable with each other. Note that the information acquisition terminal 20 has an identifier ID for identifying an individual terminal.

The present example embodiment will give description by using an example of tracking a moving body that sends a particular radio wave preliminarily registered in a database. The moving body described herein includes a movable person and a movable object. Note that, for convenience, the present example embodiment will give description by using, but not limited to, a travelable vehicle as an example of the moving body. Examples of the moving body include, but not limited to, a person holding radio-wave-sending equipment, and an object such as a vehicle, an airplane, a watercraft, or a drone. Further, examples of the radio-wave-sending equipment include, but not limited to, a smartphone, a cell phone, an electronic toll collection system (ETC) (registered trademark) terminal, and the like. The expression “vehicle” described in all example embodiments of the present invention can be rephrased as any “moving body”. Similarly, the expression “vehicle ID” related to the “vehicle” can be also rephrased as a “moving body ID”. The “vehicle ID” and the “moving body ID” are identification information assigned to each individual of moving bodies.

Further, the present example embodiment uses a road periphery as an example of an installation place of the information acquisition terminal 20, but not limiting an installation example. For example, when the moving body is a watercraft, the information acquisition terminal 20 may be arranged at sea by being buried in a buoy or the like. When the moving body is an aircraft, the information acquisition terminal 20 may be arranged in the air by being mounted on a drone or the like. Further, the information acquisition terminal 20 does not need to be arranged two-dimensionally, but may be arranged three-dimensionally along the track of the moving body.

The radio-wave-sending equipment is manufactured in such a way as to satisfy a predetermined telecommunications standard, but involves a slight individual difference due to variation of analog circuits, or the like. Thus, a radio wave has a feature value identifiable on the basis of the individual difference in equipment being an emission source of the radio wave. Examples of the feature value of a radio wave include a feature value based on a modulation error caused by a modulation analysis, a feature value based on a temporal waveform of the radio wave, and the like. Further, for example, the feature value may be a feature value indicating one or more of, but not limited to, a transient (rise and fall) of a reception signal, power spectral density of a preamble portion, error vector magnitude (EVM), an IQ phase error, an IQ imbalance amount, a frequency offset, and a symbol clock error. By collating the feature value of a radio wave being physical-layer information as described above with a preliminarily generated database, it is possible to identify one individual being an emission source of the radio wave. The radio wave reception unit 21 according to the present invention acquires the feature value of a radio wave sent from the vicinity. Note that a timing at which a radio wave is sent from an emission source is not limited to any particular timing. For example, when the emission source of a radio wave is a smartphone or the like, the timing at which the radio wave is sent is not limited to when voice communication is performed, and may be when communication is performed due to running of an application, or may be when polling communication between a cell terminal and a base station is performed.

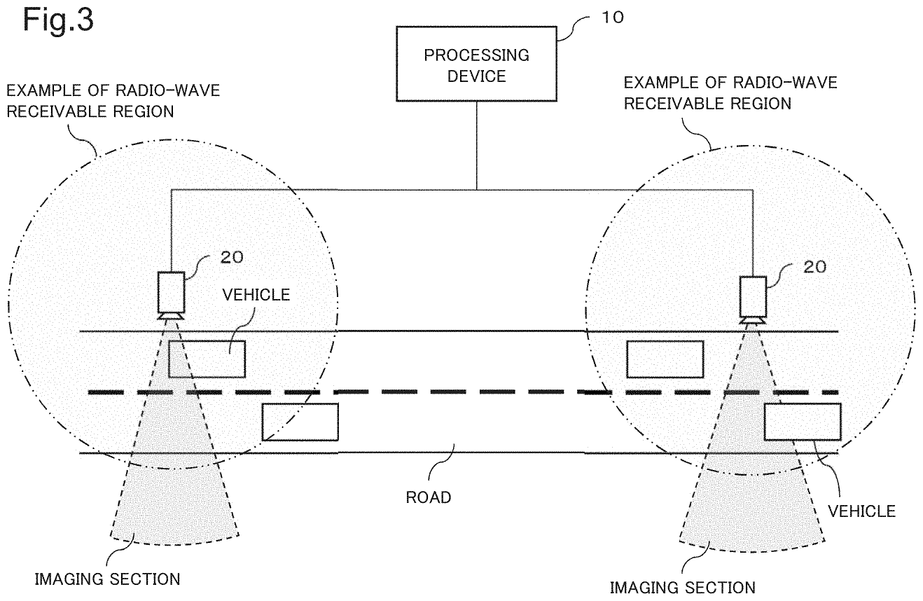

Next, a state in which the information acquisition terminal 20 according to the present example embodiment is installed on a road will be described by using FIG. 3. A plurality of information acquisition terminals 20 are installed along a road. A situation is assumed in which a plurality of vehicles travel the road. When a vehicle includes a terminal being an emission source of a radio wave, such as when an electronic toll collection system (ETC) (registered trademark) terminal is mounted on a vehicle or when a person holding a smartphone is riding on a vehicle, a radio wave is sent from the vehicle. Each of the plurality of information acquisition terminals 20 installed along the road receives, when a vehicle approaches the information acquisition terminal 20, a radio wave sent from the vehicle. For example, a traveling vehicle passes through the vicinity of a certain information acquisition terminal 20, and thereafter passes through the vicinity of another information acquisition terminal 20. In this case, there is a difference in times at which the information acquisition terminals 20 receive a radio wave sent from the vehicle.

When a vehicle sending a radio wave travels the vicinity of the information acquisition terminal 20, the radio wave reception unit 21 receives the radio wave sent from the vehicle traveling a predetermined section, and extracts a feature value of the radio wave. In the case of extracting a feature value from the received radio wave, it may be designed such that noise influence according to a characteristic of the individual information acquisition terminal 20 is removed. Examples of the radio wave reception unit 21 include, but not limited to, a directional antenna, a nondirectional antenna, and the like. Any radio wave reception unit 21 is applicable, as long as the radio wave reception unit 21 is capable of receiving a radio wave. Further, the radio wave reception unit 21 may have a radio wave analysis function for extracting a feature value of a radio wave.

The imaging unit 22 captures an image of a predetermined imaging section, and acquires a captured image including a traveling vehicle. Examples of the imaging unit 22 include, but not limited to, a visible light camera, an infrared light camera, and the like.

The code assignment unit 24 assigns a code of meta-information to data indicating the feature value of the radio wave and the captured image. The meta-information used in the present example embodiment includes time information related to a time at which the radio wave reception unit 21 receives the radio wave, or time information related to a time at which the imaging unit 22 captures the image. The meta-information used in the present example embodiment also includes an identifier ID of the information acquisition terminal 20 including the radio wave reception unit 21 and the imaging unit 22. The terminal-side communication unit 23 transmits, to the communication unit 11, the feature value of the radio wave and the captured image to which the code assignment unit 24 assigns the meta-information.

The communication unit 11 receives information including the feature value of the radio wave and the captured image transmitted by the terminal-side communication unit 23. The image processing unit 19 recognizes and extracts a vehicle image from the captured image received by the communication unit 11. The image processing unit 19 assigns, to each vehicle image, a vehicle ID according to an individual vehicle, on the basis of a feature of the extracted vehicle image. Any feature of the vehicle image is applicable, as long as the feature is capable of identifying an individual vehicle on the basis of, for example, a vehicle type, a vehicle color, a vehicle shape, a number plate, a flaw or a deterioration state of the vehicle, a type of a component of the vehicle, and the like. A publicly known art can be used for identification of an individual vehicle.

The storage unit 13 stores information indicating the feature value of the radio wave received by the communication unit 11, the vehicle image extracted by the image processing unit 19, and the vehicle ID.

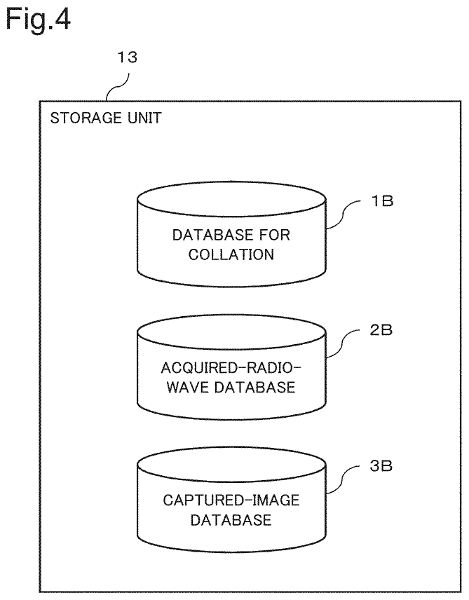

A concept of a database included in the storage unit 13 will be described by using FIG. 4. The storage unit 13 includes a database for collation 1B, an acquired-radio-wave database 2B, and a captured-image database 3B. In the database for collation 1B, a feature value of a radio wave sent by an individual to be identified is preliminarily registered. In the acquired-radio-wave database 2B, the feature value of the radio wave acquired by the radio wave reception unit 21 and the meta-information in association therewith are stored for each record. In the captured-image database 3B, the captured image acquired by the imaging unit 22, the meta-information, the vehicle image extracted by the image processing unit 19, and the vehicle ID are stored in association with one another.

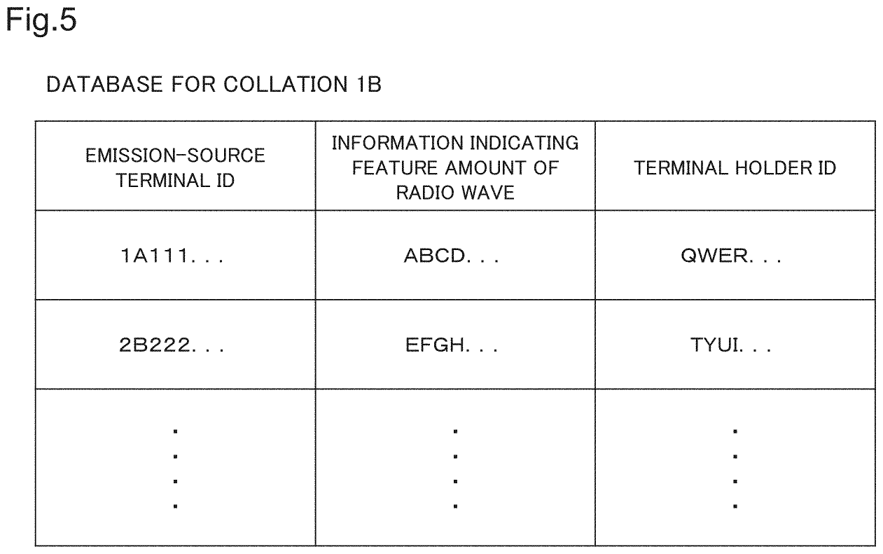

A structure of data included in the database for collation 1B will be described by using FIG. 5. In the database for collation 1B, an emission-source terminal ID indicating a terminal being an emission source of a radio wave, and information indicating a feature value of a radio wave sent by the emission-source terminal are stored in association with each other. Information indicating a holder of the emission-source terminal may be also associated with the feature value of the radio wave.

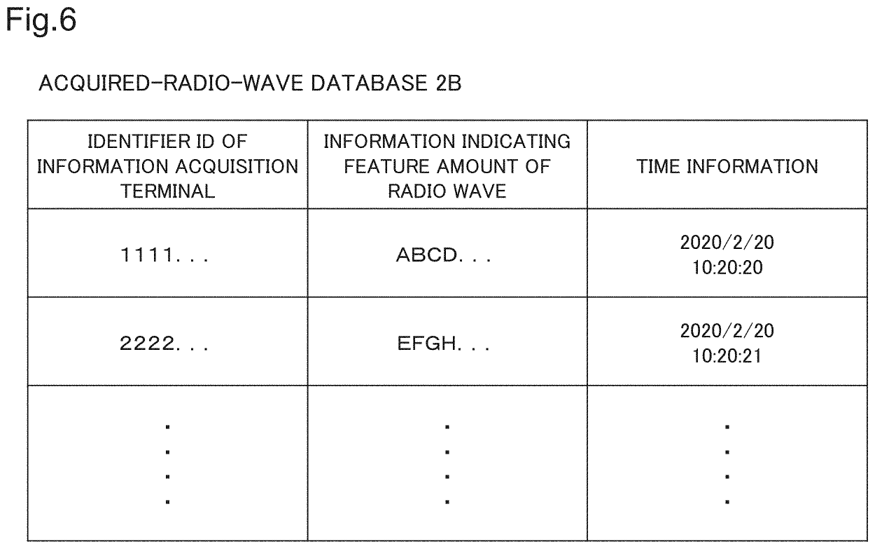

A structure of data included in the acquired-radio-wave database 2B will be described by using FIG. 6. In the acquired-radio-wave database 2B, information indicating the feature value of the acquired radio wave, the identifier ID of the information acquisition terminal 20 having acquired the radio wave, and the time information are stored in association with one another.

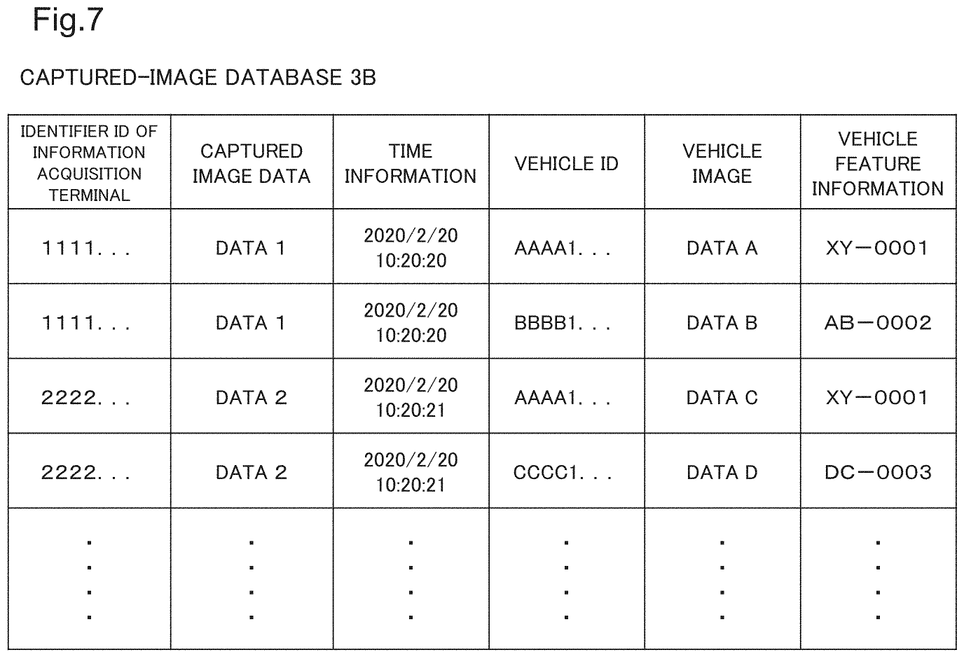

A structure of data included in the captured-image database 3B will be described by using FIG. 7. In the captured-image database 3B, data indicating the captured image captured by the imaging unit 22, the identifier ID of the information acquisition terminal 20 having acquired the captured image, the time information, the vehicle image extracted by the image processing unit 19 from the captured image, and the vehicle ID are stored in association with one another. Further, feature information capable of identifying a vehicle may be also stored in association with the above. The feature information of a vehicle is, for example, a number plate determined from the captured image.

The collation unit 12 collates the feature value of the radio wave stored in the acquired-radio-wave database 2B with the feature value of the radio wave stored in the database for collation 1B. The collation unit 12 may execute collation at a timing when, for example, a feature value of a radio wave is newly stored in the acquired-radio-wave database 2B. Further, the collation unit 12 may execute collation when the information stored in the acquired-radio-wave database 2B is updated, or when a user accessing the processing device 10 performs an operation. The timing at which the collation unit 12 executes collation is not limited to any particular timing.

The identification unit 14 identifies a feature value of a radio wave successfully collated by the collation unit 12, from among the feature values of the radio waves stored in the acquired-radio-wave database 2B. Then, the identification unit 14 searches for, from the acquired-radio-wave database 2B, one or more combinations of time information and identifier IDs associated with the feature value of the radio wave. Then, the identification unit 14 refers to the time information and the identifier ID stored in the captured-image database 3B, and searches for a vehicle ID from a record having the same time information and the same identifier ID as the above-described information searched for from the acquired-radio-wave database 2B. By repeating the search, a vehicle ID of a vehicle being an emission source of the radio wave is identified.

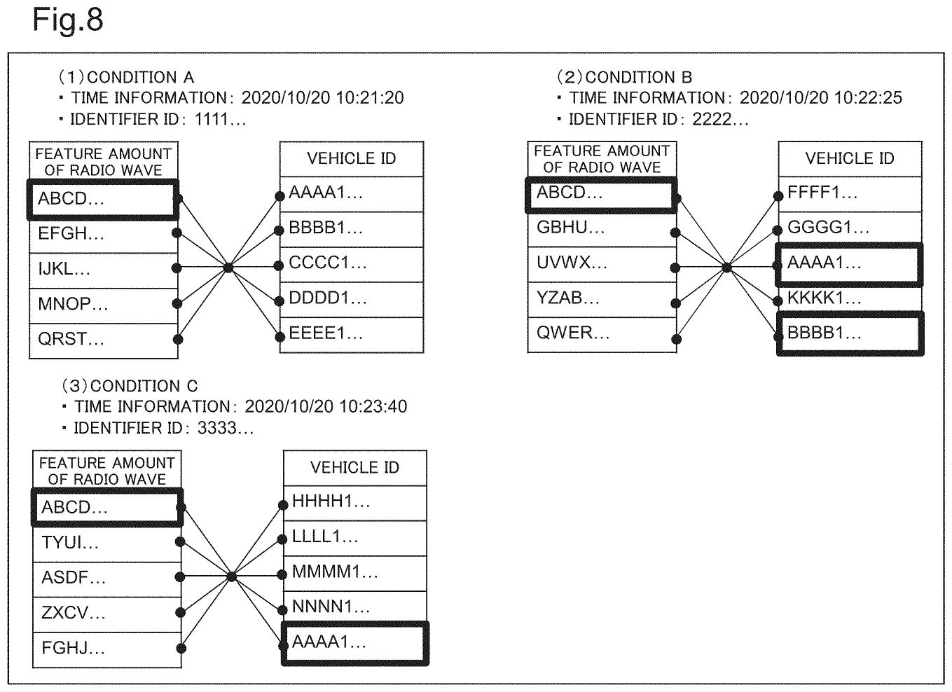

Next, processing of identifying, by the identification unit 14, a vehicle being an emission source of the radio wave will be described in detail by using a conceptual diagram of FIG. 8. (1) to (3) in FIG. 8 are conceptual diagrams indicating a group of feature values of radio waves (or information indicating feature values of radio waves) and vehicle IDs having common time information and a common identifier ID. In other words, (1) to (3) indicate one or more vehicle bodies captured by the same information acquisition terminal 20 at the same time, and feature values of one or more received radio waves. Conditions A to C are conditions relating to time information and an identifier ID. Herein, a process of identifying a vehicle body being an emission source of the radio wave will be described by using, as an example, a feature value “ABCD . . . ” of a radio wave illustrated in FIG. 8.

The identification unit 14 first refers to the condition A in (1). A plurality of vehicle IDs stored in the captured-image database 3B may be associated with a plurality of feature values of radio waves stored in the acquired-radio-wave database 2B. There are a plurality of candidates for a vehicle body sending a radio wave having the feature value “ABCD . . . ”. The identification unit 14 then refers to the condition B in (2) as well, and narrows down the vehicle IDs associated with the feature value “ABCD . . . ” under the conditions A and B to “AAAA1 . . . ” or “BBBB1 . . . ”. Further, the identification unit 14 refers to the condition C in (3) as well, and narrows down the vehicle ID associated with the feature value “ABCD . . . ” under the conditions A, B, and C to one “AAAA1 . . . .”

At a stage where there are an insufficient number of pieces of data acquired by the information acquisition terminal 20 and there are few conditions to be referred to (for example, when only the condition A in FIG. 8 is referred to), it is impossible to find out a vehicle ID from the feature value of the radio wave, which results in a plurality of vehicle IDs being searched. When the number of pieces of data acquired by the information acquisition terminal 20 is increased and there are many conditions to be referred to (for example, when the conditions A to C in FIG. 8 are referred to), it is possible to narrow down to one vehicle ID from the feature value of the radio wave. As described above, the identification unit 14 sequentially refers to conditions including time information and an identifier ID, and narrows down vehicle IDs associated with the feature value of the radio wave under a plurality of conditions. The identification unit 14 then identifies, by the narrowing, a vehicle ID related to the feature value of the radio wave. Note that the information identified by the identification unit 14 may be not only a vehicle ID, but may be also a vehicle image.

Note that, when the identification unit 14 refers to the time information stored in the captured-image database 3B, the identification unit 14 does not need to refer to only an identical time strictly, and it may be designed such that any time error is allowed for reference. Further, in consideration of a structure and arrangement of the information acquisition terminal 20, a condition (time information, an identifier ID, and the like) for use in association of a feature value of a radio wave with a vehicle ID may be changed according to, for example, arrangement of the radio wave reception unit 21 and the imaging unit 22, a radio-wave receivable range, and an imaging section. For example, a plurality of identifier IDs for use in association may be set in consideration of arrangement of the information acquisition terminal 20, or it may be designed such that information associated with at least one of a plurality of predetermined identifier IDs are able to be referred to.

The output unit 15 outputs information associated with the vehicle ID identified by the identification unit 14. The information output by the output unit 15 includes, for example: the vehicle image, the time information, the identifier ID of the information acquisition terminal 20, and the number plate information on the vehicle stored in the captured-image database 3B; the feature value of the radio wave and the time information stored in the acquired-radio-wave database 2B; the emission-source terminal ID and the information on a terminal holder stored in the database for collation 1B; and the like. Further, the output unit 15 may display the conceptual diagrams illustrated in FIG. 8, a process in which the identification unit 14 identifies a vehicle being an emission source of a target radio wave, and the like. The information output by the output unit 15 is not limited to the above. Further, the output unit 15 may cause, for example, an unillustrated display unit included in the processing device 10 to display information, or the output unit 15 may display information for a user. The output unit 15 may output, to a user accessing the processing device 10, an instruction to display information.

Next, one example of a hardware configuration that implements the processing device 10 and the information acquisition terminal 20 by using one or more computers will be described. The function units included in the processing device 10 and the information acquisition terminal 20 are implemented by any combination of hardware and software, mainly including, for example, a central processing unit (CPU) of any computer, a memory, a program loaded on a memory, a storage unit such as a hard disk storing the program, and an interface for network connection. It should be understood by a person skilled in the art that there are various modification examples of a method of implementing the function units and a device therefor. Note that, the storage unit is also able to store, besides a program previously stored before shipment of the device, a program downloaded from, for example, a storage medium such as an optical disk, a magneto-optical disk, and a semiconductor flash memory, or from a server on the Internet.

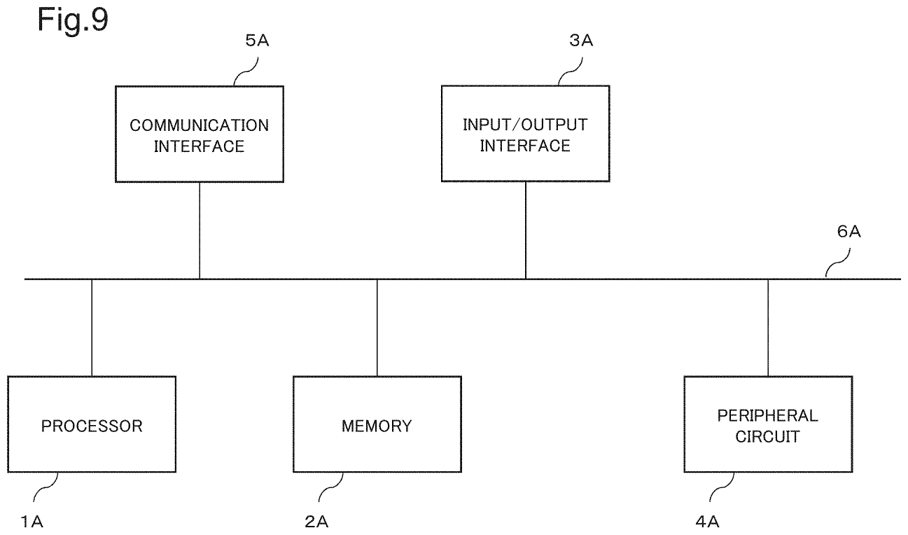

FIG. 9 is a block diagram exemplarily illustrating a hardware configuration of the processing device 10 and the information acquisition terminal 20. As illustrated in FIG. 9, the processing device 10 and the information acquisition terminal 20 include a processor 1A, a memory 2A, an input/output interface 3A, a peripheral circuit 4A, a communication interface 5A, and a bus 6A. The peripheral circuit 4A includes various modules. The processing device 10 and the information acquisition terminal 20 do not need to include the peripheral circuit 4A. Note that the processing device 10 and the information acquisition terminal 20 may be configured by a plurality of physically and/or logically separated devices. In this case, each of the plurality of devices may include the above-described hardware configuration.

The bus 6A is a data transmission line for the processor 1A, the memory 2A, the input/output interface 3A, the peripheral circuit 4A, and the communication interface 5A to transmit and receive data to and from one another. The processor 1A is an arithmetic processing device such as a CPU, a graphics processing unit (GPU), or a microprocessor. The processor 1A can execute processing according to, for example, various kinds of programs stored in the memory 2A.

The memory 2A is, for example, a memory such as a random access memory (RAM) or a read only memory (ROM), and stores a program and various kinds of data. The memory 2A stores a database in which the feature value of the radio wave received by the information acquisition terminal 20. The input/output interface 3A includes, for example, an interface for acquiring information from an input device, an external device, an external storage unit, an external sensor, a camera, or the like, and an interface for outputting information to an output device, an external device, an external storage unit, or the like. The input device is, for example, a touch panel, a keyboard, a mouse, a microphone, a camera, and the like. The output device is, for example, a display, a speaker, a printer, a lamp, and the like.

The processor 1A is able to issue a command to each of the modules, and is able to perform an operation on the basis of results of operations performed by the modules. The processor 1A identifies the moving body sending the radio wave, based on the plurality of images captured by the information acquisition terminal 20 and associated with the feature value of the radio wave. The communication interface 5A allows the processing device 10 and the information acquisition terminal 20 to communicate with an external device, and besides, allows the processing device 10 and the information acquisition terminal 20 to communicate with each other. Note that some of the functions of the processing device 10 and the information acquisition terminal 20 may be configured by a computer.

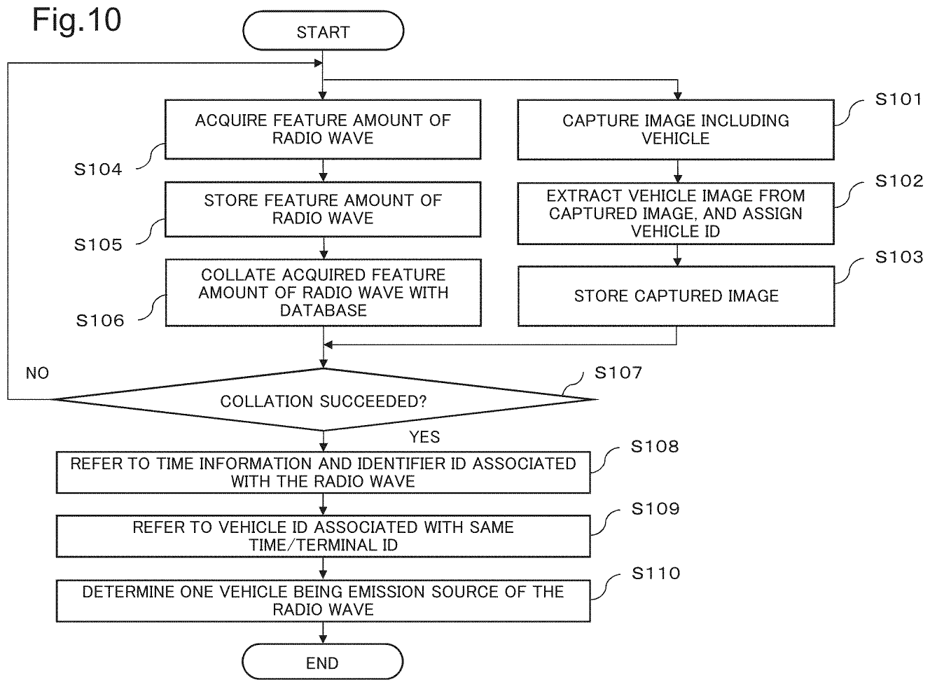

Next, flow of processing performed by the moving body tracking system 100 according to the present example embodiment will be described by using a flowchart of FIG. 10. One or more information acquisition terminals 20 are installed along a road, and vehicles pass through the vicinity of the information acquisition terminal 20 one after another. The imaging unit 22 captures an image of a predetermined imaging section, and acquires a captured image including a traveling vehicle (S101). The image processing unit 19 extracts a vehicle image from the captured image, and assigns a vehicle ID to the vehicle image (S102). The storage unit 13 stores the captured image captured by the imaging unit 22, the vehicle image extracted by the image processing unit 19, and the vehicle ID (S103).

The radio wave reception unit 21 included in the information acquisition terminal 20 acquires a feature value of an acquired radio wave (S104). The storage unit 13 stores the feature value of the radio wave acquired by the radio wave reception unit 21 (S105). Note that, in S103 and S105, the storage unit 13 stores the feature value of the radio wave and the captured image in association with an identifier ID of the information acquisition terminal 20 and time information.

The collation unit 12 then collates the feature value of the radio wave acquired by the radio wave reception unit 21 and stored in the storage unit 13, with a feature value of a radio wave preliminarily stored in the database for collation 1B (S106). When collation is failed, S101 and S104 are executed again (NO in S107). When collation is succeeded, the identification unit 14 refers to the acquired-radio-wave database 2B, and searches for time information and an identifier ID associated with the radio wave (YES in S107, and S108). The identification unit 14 then refers to the captured-image database 3B, and refers to a vehicle ID from a record having the same time information and the same identifier ID as the information identified in S108 (S109). Thereafter, the identification unit 14 sequentially refers to vehicle IDs associated with the time information and the identifier ID, and narrows down vehicle IDs associated with the feature value of the radio wave under a plurality of conditions. As a result of the narrowing, the identification unit 14 identifies one vehicle being an emission source of the radio wave (S110).

The moving body tracking system 100 according to the present example embodiment described above is able to more accurately identify one moving body that sends a radio wave having a feature value preliminarily registered in a database, even when there are a plurality of moving bodies sending radio waves.

Further, the moving body tracking system 100 according to the present example embodiment performs collation by using a feature value that is physical-layer information on a received radio wave. Thus, there is no need of mutual communication with equipment being an emission source of a radio wave, unlike an approach to identify emission-source equipment by using an IP address of the equipment or the like. Accordingly, it is possible to identify an emission source of a radio wave without causing equipment or a moving body being an emission source of a radio wave to recognize the presence of a terminal acquiring a radio wave.

Further, since only a user allowed to access the processing device 10 is able to identify a moving body being an emission source of a radio wave, it is possible to maintain confidentiality in dealing with individuality identifiable information.

### Second Example Embodiment

A second example embodiment assumes that the information acquisition terminal 20 according to the first example embodiment captures an image of a person riding on a moving body. The second example embodiment is different from the above-described first example embodiment in that, when the imaging unit 22 captures a person image, the captured-image database 3B stores information relating to the person image, the image processing unit 19 identifies a person from the captured image, and the identification unit 14 identifies a person having a terminal being an emission source of a radio wave. Other configurations of the information acquisition terminal 20 are the same as the configurations according to the first example embodiment. The portions overlapping with the first example embodiment will not be described.

The imaging unit 22 captures an image including a person. The imaging unit 22 may capture an image of, for example, a person driving a vehicle, or a person riding on a vehicle.

The image processing unit 19 recognizes and extracts a person image from the captured image. Further, the image processing unit 19 assigns a person ID for identifying an individual on the basis of a feature of the extracted person image. Note that, the image processing unit 19 may extract a face image from the captured image, or may extract a person image including a face image. Further, the person image may be photographed from the back or the side of a person, and the face image may be unclear. The person image may include a part of a person's body. In a process of identifying an individual from a person image and assigning a person ID, facial recognition or the like may be used. However, description therefor will not be given, since facial recognition is publicly and widely known.

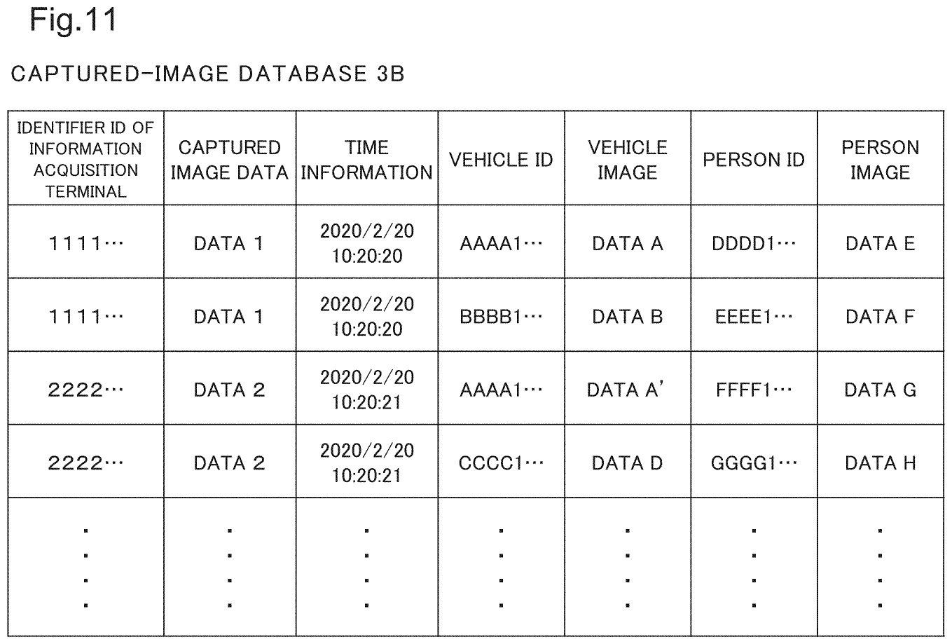

A structure of data included in a captured-image database 3B according to the present example embodiment will be described by using FIG. 11. In the captured-image database 3B according to the present example embodiment, data indicating the captured image captured by the imaging unit 22, the identifier ID of the information acquisition terminal 20 having acquired the captured image, and the time information are stored in association with one another. Further, in the captured-image database 3B according to the present example embodiment, the vehicle image extracted by the image processing unit 19 from the captured image, the vehicle ID, the person image, and the person ID are stored in association with one another. Note that the data stored in the captured-image database 3B can be changed as appropriate according to a type of a moving body. For example, when the moving body is a person, the captured-image database 3B does not always need to store the vehicle image and the vehicle ID.

The identification unit 14 identifies a feature value of a radio wave successfully collated by the collation unit 12, from among the feature values of the radio waves stored in the acquired-radio-wave database 2B. Then, the identification unit 14 searches for one or more combinations of time information and identifier IDs associated with the feature value of the radio wave.

Then, the identification unit 14 refers to the time information and the identifier ID stored in the captured-image database 3B, and identifies at least either one vehicle ID or one person ID having the same condition relating to the associated time information and the identifier ID as the feature value of the radio wave identified on the acquired-radio-wave database 2B. Similarly to the first example embodiment, the identification unit 14 sequentially refers to conditions including time information and an identifier ID, and narrows down vehicle IDs or person IDs associated with the feature value of the radio wave under a plurality of conditions. The identification unit 14 then identifies, by the narrowing, a vehicle ID or a person ID related to the feature value of the radio wave.

Note that, when the identification unit 14 refers to the time information stored in the captured-image database 3B, the identification unit 14 does not need to refer to only an identical time strictly, and it may be designed such that any time error is allowed for reference. Further, in consideration of a structure and arrangement of the information acquisition terminal 20, a condition (time information, an identifier ID, and the like) for use in association of a feature value of a radio wave with a vehicle ID may be changed according to arrangement of the radio wave reception unit 21 and the imaging unit 22, a radio-wave receivable range, an imaging section, and the like. For example, a plurality of identifier IDs for use in association may be set in consideration of arrangement of the information acquisition terminal 20, or it may be designed such that information associated with at least one of a plurality of predetermined identifier IDs can be referred to.

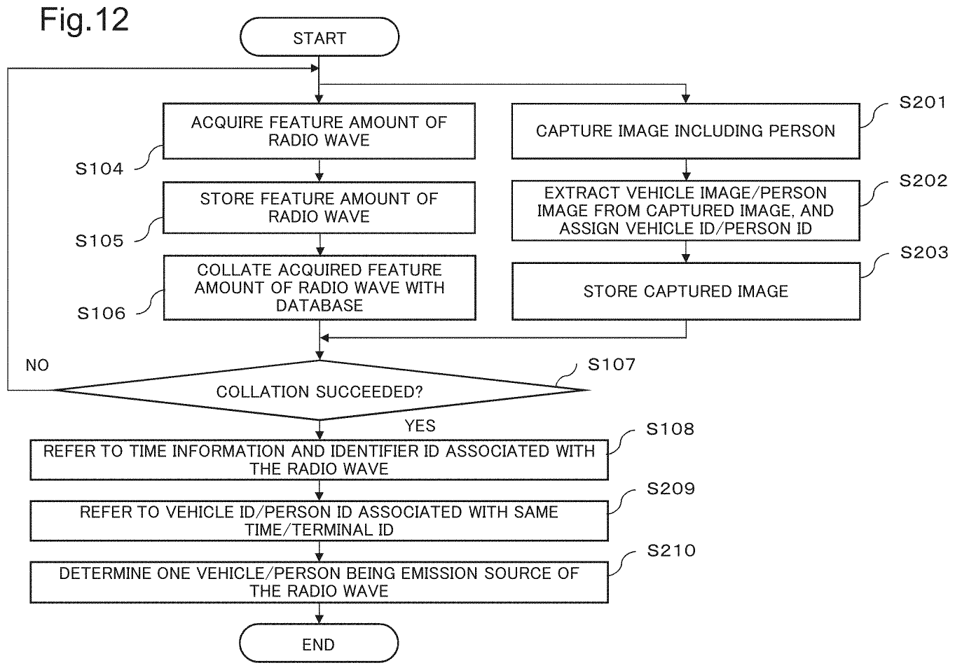

Next, flow of processing performed by a moving body tracking system 100 according to the present example embodiment will be described by using a flowchart of FIG. 12. The portions overlapping with the first example embodiment will not be described. One or more information acquisition terminals 20 are installed along a road, and vehicles pass through the vicinity of the information acquisition terminal 20 one after another. The imaging unit 22 captures an image of a predetermined imaging section, and acquires a captured image including a person (S201). The image processing unit 19 extracts a vehicle image and a person image from the captured image, and assigns a vehicle ID and a person ID to the vehicle image and the person image, respectively (S202). The storage unit 13 stores the captured image captured by the imaging unit 22, the vehicle image and the person image extracted by the image processing unit 19, and the vehicle ID and the person ID assigned by the image processing unit 19 (S203).

In parallel with S201 to S203, the collation unit 12 collates the feature value of the radio wave acquired by the radio wave reception unit 21 and stored in the storage unit 13, with a feature value of a radio wave preliminarily stored in the database for collation 1B (S106). When collation is failed, S201 and S104 are executed again (NO in S107). When collation is succeeded, the identification unit 14 refers to the acquired-radio-wave database 2B, and identifies time information and an identifier ID associated with the radio wave (YES in S107, and S108). The identification unit 14 then refers to the captured-image database 3B, and refers to a vehicle ID or a person ID associated with the same information as the time information and the identifier ID identified in S108 (S209). Thereafter, the identification unit 14 sequentially refers to vehicle IDs or person IDs associated with the time information and the identifier ID, and narrows down vehicle IDs or person IDs associated with the feature value of the radio wave under a plurality of conditions. As a result of reference, the identification unit 14 identifies at least either one vehicle or one person being an emission source of the radio wave (S210). Note that the process in which the identification unit 14 identifies a vehicle or a person being an emission source is similar to the first example embodiment.

The moving body tracking system 100 according to the present example embodiment described above is able to more accurately identify a moving body that has an emission source of a radio wave having a feature value preliminarily registered in a database, even when there are a plurality of moving bodies sending radio waves. Further, for example, even when a person carrying a smartphone changes vehicles from one to another, the moving body tracking system 100 according to the present example embodiment described above is able to determine which of the person carrying a smartphone or the vehicle an emission source of a radio wave depends on.

### Third Example Embodiment

A third example embodiment assumes that a moving body sends a radio wave different from a radio wave having a feature value used for collation with the database for collation 1B. A moving body tracking system 100 according to the present example embodiment is different from those according to the first and second example embodiments in that the moving body tracking system 100 has a function of storing, in association with each other, a plurality of feature values of radio waves sent by the moving body, and registering, in a watchlist, a feature value of a radio wave unregistered in the database for collation 1B.

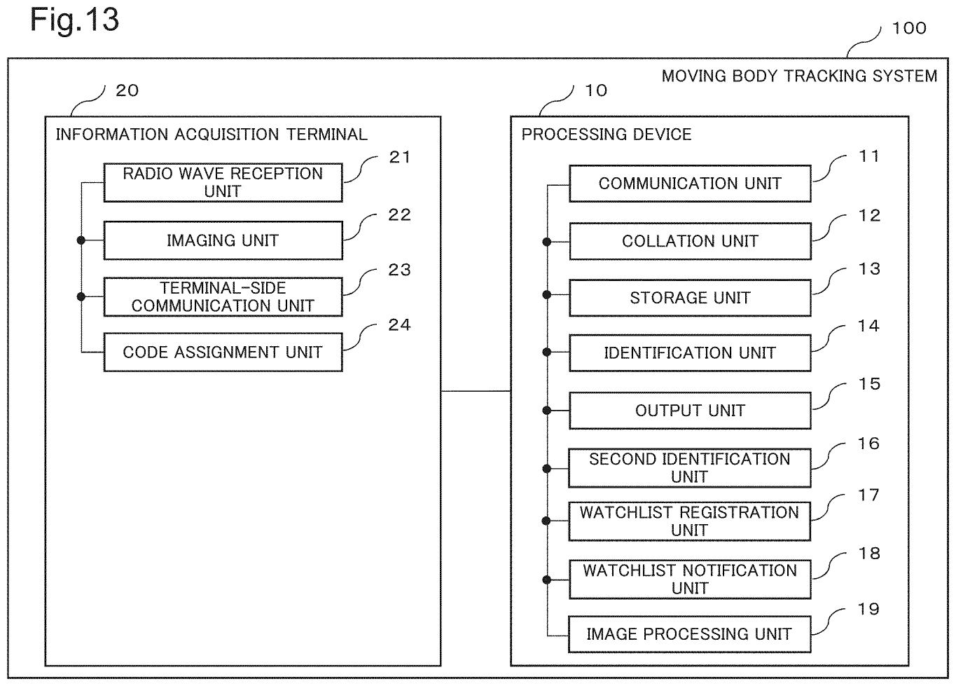

The third example embodiment of the present invention will be described. An overview of the moving body tracking system 100 according to the present example embodiment will be described by using a function block diagram of FIG. 13. A processing device 10 is different from those according to the first and second example embodiments in that the processing device 10 further includes a second identification unit 16, a watchlist registration unit 17, and a watchlist notification unit 18. The processing device 10 is communicable with one or more information acquisition terminals 20, and receives information acquired by the information acquisition terminal(s) 20.

Hereinafter, for illustrative purposes, the feature value of the radio wave from which a vehicle being an emission source is identified by an identification unit 14 according to the first and second example embodiments will be referred to as a feature value of a first radio wave. The second identification unit 16 refers to, from among pieces of data stored in an acquired-radio-wave database 2B, a plurality of combinations of time information and identifier IDs of the information acquisition terminals 20 associated with the feature value of the first radio wave. The second identification unit 16 then identifies, on the basis of the plurality of referred combinations of time information and identifier IDs, a feature value of a radio wave acquired by the same information acquisition terminal 20 at the same time as the feature value of the first radio wave. The feature value of the radio wave identified by the second identification unit 16 will be referred to as a feature value of a second radio wave. Note that the second radio wave is not necessarily a radio wave sent from one piece of equipment. This is because radio waves having different feature values are sent as many as emission-source terminals mounted on a vehicle.

When the second identification unit 16 refers to the time information stored in the acquired-radio-wave database 2B or the like, the second identification unit 16 does not need to refer to only an identical time strictly, and it may be designed such that any time error is allowed for reference.

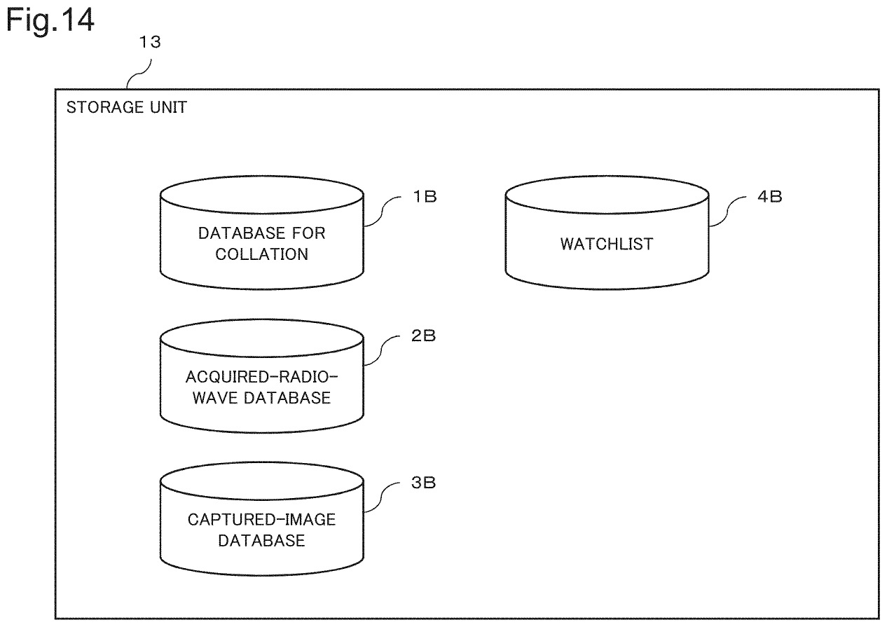

A concept of a database included in a storage unit 13 according to the present example embodiment will be described by using FIG. 14. The storage unit 13 is different from those according to the first and second example embodiments in that the storage unit 13 further includes a watchlist 4B that stores a feature value of a radio wave to be observed.

The watchlist registration unit 17 registers the feature value of the second radio wave in the watchlist 4B. The watchlist notification unit 18 refers to the acquired-radio-wave database 2B at any timing. When there is the same feature value as the feature value of the second radio wave registered in the watchlist 4B, the watchlist notification unit 18 instructs an output unit 15 to perform notification. The output unit 15 notifies a user of detecting a radio wave having a feature value registered in the watchlist 4B. Note that, the acquired-radio-wave database 2B may be referred to at a timing of preliminarily set frequency, or may be referred to every time new information is registered in the acquired-radio-wave database 2B. The timing of reference is not limited to any particular timing.

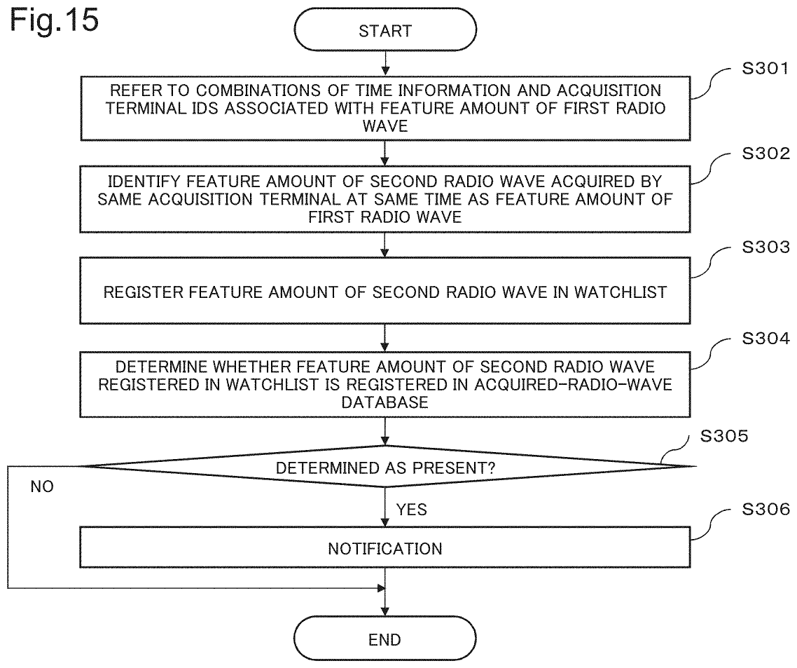

Next, flow of processing performed by the moving body tracking system 100 according to the present example embodiment will be described by using a flowchart of FIG. 15. A case is assumed in which a moving body sends a radio wave different from a radio wave having a feature value collated with the database for collation 1B. The second identification unit 16 refers to, from among pieces of data stored in the acquired-radio-wave database 2B, a plurality of combinations of time information and identifier IDs of the information acquisition terminals 20 associated with the feature value of the first radio wave (S301). The second identification unit 16 then identifies, on the basis of the plurality of referred combinations of time information and identifier IDs of the information acquisition terminals 20, a feature value of a radio wave acquired by the same information acquisition terminal 20 at the same time as the feature value of the first radio wave (S302).

The watchlist registration unit 17 registers the feature value of the second radio wave in the watchlist 4B (S303). The watchlist notification unit 18 refers to the acquired-radio-wave database 2B at any timing, and determines the presence of the same feature value as the feature value of the second radio wave registered in the watchlist 4B (S304). When determined as present, the watchlist notification unit 18 instructs the output unit 15 to perform notification (YES in S305). The output unit 15 notifies a user of detecting a radio wave having a feature value registered in the watchlist 4B (S306).

With the above-described operation, the moving body tracking system 100 according to the present example embodiment is able to identify a moving body sending a radio wave known by a database and thereafter register, when the same vehicle sends an unknown radio wave, a feature value of the unknown radio wave in such a way that the known radio wave and the unknown radio wave are in association with each other. Accordingly, a user who uses the moving body tracking system 100 is able to acquire a feature value of a radio wave that is information capable of identifying a terminal, regarding another emission-source terminal moving together with an emission-source terminal of a radio wave known by a database.

Further, the moving body tracking system 100 according to the present example embodiment acquires information (a feature value of a radio wave) necessary for collation with a database, by receiving a sent radio wave. Thus, there is no need of mutual communication with equipment being an emission source of a radio wave, unlike an approach to identify emission-source equipment by using an IP address of the equipment or the like. Accordingly, it is possible to identify an emission source of a radio wave without causing equipment or a moving body being an emission source of a radio wave to recognize the presence of a terminal acquiring a radio wave.

### Fourth Example Embodiment

A fourth example embodiment assumes that a moving body sending a radio wave unregistered in a database is identified in a predetermined area. The predetermined area may be, for example, an area where a moving body given permission in advance is limitedly allowed for passage, an area where only a vehicle or a staff registered in advance is admitted for entry, a security area, or an area merely set by a user.

The moving body tracking systems 100 according to the first to third example embodiments identify an emission source of a radio wave successfully collated with a database (a positive list approach). On the other hand, in a moving body tracking system 100 according to the present example embodiment, an identification unit 14 identifies a moving body being an emission source of a radio wave having a feature value unsuccessfully collated with a database (a negative list approach). The present example embodiment is different from the first to third example embodiments in the above-described point. Other configurations of the moving body tracking system 100 are the same as the configurations according to the first to third example embodiments. The portions overlapping with the first to third example embodiments will not be described.

One or more information acquisition terminals 20 are installed in a predetermined area. A moving body passes through the vicinity of the information acquisition terminal 20. A database for collation 1B preliminarily stores, for example, for a moving body permitted for passage through the predetermined area, a feature value of a radio wave sent by the moving body.

The identification unit 14 identifies a feature value of a radio wave unsuccessfully collated by a collation unit 12, from among the feature values of the radio waves stored in an acquired-radio-wave database 2B. Then, the identification unit 14 identifies one or more combinations of time information and identifier IDs associated with the feature value of the radio wave.

Then, the identification unit 14 refers to the time information and the identifier ID stored in a captured-image database 3B, and identifies at least either one vehicle ID or one person ID having the same condition relating to the associated time information and the identifier ID as the feature value of the radio wave identified on the acquired-radio-wave database 2B. Similarly to the first to third example embodiments, the identification unit 14 sequentially refers to conditions including time information and an identifier ID, and narrows down vehicle IDs or person IDs associated with the feature value of the radio wave under a plurality of conditions. The identification unit 14 then identifies, by the narrowing, a vehicle ID or a person ID related to the feature value of the radio wave.

Note that, when the identification unit 14 refers to the time information stored in the captured-image database 3B, the identification unit 14 does not need to refer to only an identical time strictly, and it may be designed such that any time error is allowed for reference. Further, in consideration of a structure and arrangement of the information acquisition terminal 20, a condition (time information, an identifier ID, and the like) for use in association of a feature value of a radio wave with a vehicle ID may be changed according to arrangement of a radio wave reception unit 21 and an imaging unit 22, a radio-wave receivable range, an imaging section, and the like. For example, a plurality of identifier IDs for use in association may be set in consideration of arrangement of the information acquisition terminal 20, or it may be designed such that information associated with at least one of a plurality of predetermined identifier IDs is able to be referred to.

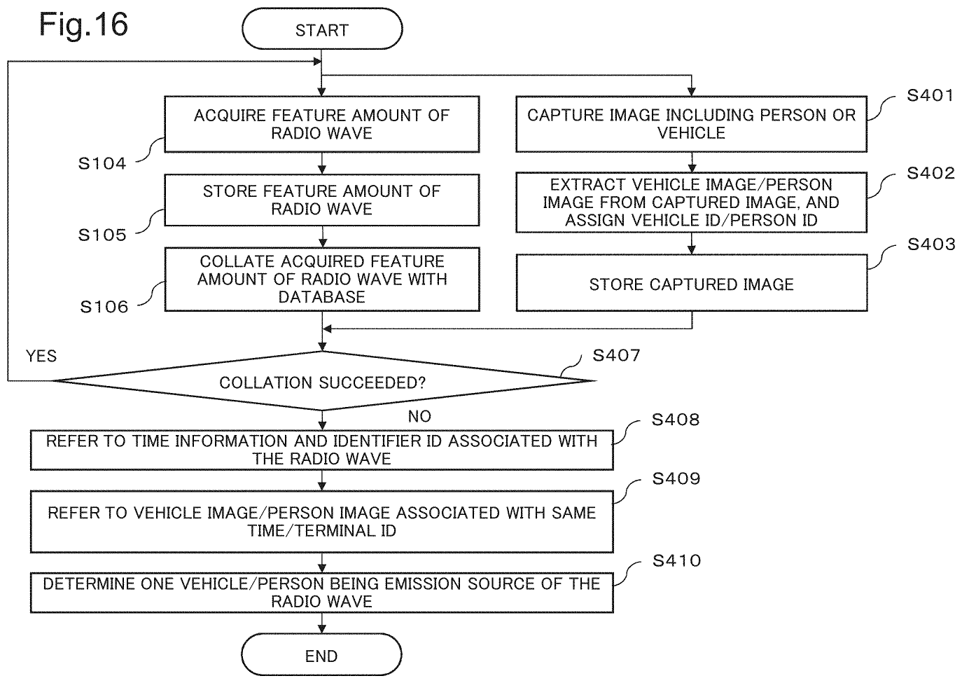

Next, flow of processing performed by the moving body tracking system 100 according to the present example embodiment will be described by using a flowchart of FIG. 16. The portions overlapping with the first to third example embodiments will not be described.

The collation unit 12 collates the feature value of the radio wave acquired by the radio wave reception unit 21 and stored in the storage unit 13, with a feature value of a radio wave preliminarily stored in a database for collation 1B (S106). When collation is succeeded, S104 and S401 are executed again (YES in S407). When collation is failed, the identification unit 14 refers to the acquired-radio-wave database 2B, and identifies time information and an identifier ID associated with the radio wave (NO in S407, and S408). The identification unit 14 then refers to the captured-image database 3B, and refers to at least either a vehicle image or a person image associated with the same information as the time information and the identifier ID identified in S408 (S409). As a result of reference, the identification unit 14 identifies at least either a vehicle ID or a person ID having an emission source of the radio wave (S410). Note that the process in which the identification unit 14 identifies a vehicle or a person being an emission source is similar to the first example embodiment.

With the above-described operation, the moving body tracking system 100 according to the present example embodiment is able to identify, when a radio wave unknown by a database is received, a moving body being an emission source of the unknown radio wave, and store the moving body in association with a feature value of the unknown radio wave. Accordingly, it is possible to identify, when a suspicious radio wave unknown by a database is sent in a predetermined area, a moving body being an emission source of the suspicious radio wave, and acquire information on the moving body.

### Fifth Example Embodiment

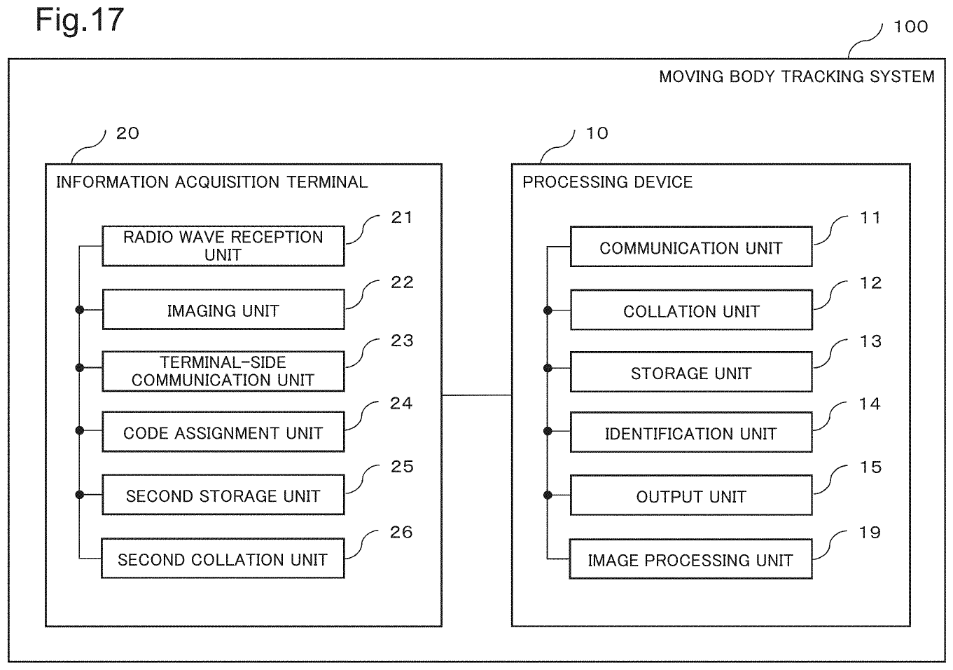

A moving body tracking system 100 according to a fifth example embodiment is different from those according to the first to fourth example embodiments, in that an information acquisition terminal 20 includes a second storage unit 25 and a second collation unit 26, and collation of a feature value of a radio wave can be performed by the information acquisition terminal 20. The fourth example embodiment of the present invention will be described. An overview of the moving body tracking system 100 according to the present example embodiment will be described by using a function block diagram of FIG. 17. Other configurations of the moving body tracking system 100 are the same as the configurations according to the first to fourth example embodiments. The portions overlapping with the first to fourth example embodiments will not be described.

The information acquisition terminal 20 includes the second storage unit 25 and the second collation unit 26. The second storage unit 25 stores data indicating a feature value of a radio wave received by a communication unit 11. Further, the second storage unit 25 stores a captured image captured by the imaging unit 22. The second storage unit 25 may store data at a timing when the information acquisition terminal 20 acquires data, or may store data every certain period of time. The timing at which the second storage unit 25 stores data is not limited to any particular timing.

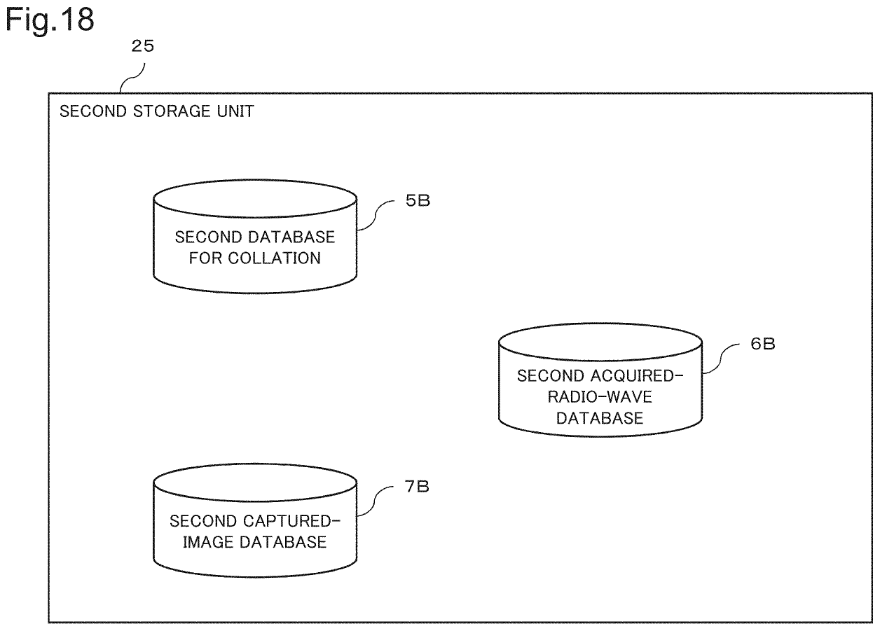

A concept of a database included in the second storage unit 25 will be described by using FIG. 18. The second storage unit includes a second database for collation 5B, a second acquired-radio-wave database 6B, and a second captured-image database 7B. A structure of data included in each database is the same as the structure of each database included in a storage unit 13. The second database for collation 5B, the second acquired-radio-wave database 6B, and the second captured-image database 7B correspond to the database for collation 1B, the acquired-radio-wave database 2B, and the captured-image database 3B, respectively.

The communication unit 11 transmits collation data included in the database for collation 1B. The terminal-side communication unit 23 receives the collation data transmitted by the communication unit 11. The second database for collation 5B included in the second storage unit 25 stores the collation data received by the terminal-side communication unit 23. At this time, the second database for collation 5B may overwrite and update already-included collation data with newly-received collation data, or may simply add received collation data to already-included collation data.

The second collation unit 26 collates the feature value of the radio wave stored in the second acquired-radio-wave database 6B with the feature value of the radio wave stored in the second database for collation 5B. The second collation unit 26 may execute collation at a timing when a feature value of a radio wave is newly stored in the second acquired-radio-wave database 6B. Further, the second collation unit 26 may execute collation at a timing when the information stored in the second acquired-radio-wave database 6B is updated. The timing at which the collation unit 12 executes collation is not limited to any particular timing.

When the second collation unit 26 succeeds in collation, the terminal-side communication unit 23 transmits information indicating a feature value of a successfully-collated radio wave, time information and an identifier ID associated with the feature value of the radio wave, and captured image data captured at the same time as a reception time of the radio wave. Note that the information indicating a feature value of a radio wave may be ID information or the like alternatively indicating a feature value of a radio wave.

The communication unit 11 receives the data transmitted from the terminal-side communication unit 23. The storage unit 13 stores the data received by the communication unit 11.

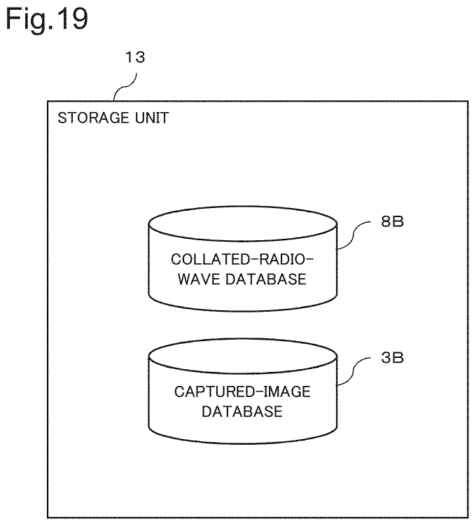

A concept of a database included in the storage unit 13 will be described by using FIG. 19. The storage unit 13 according to the present example embodiment further includes a collated-radio-wave database 8B. Other configurations are the same as those according to the first to fourth example embodiments.

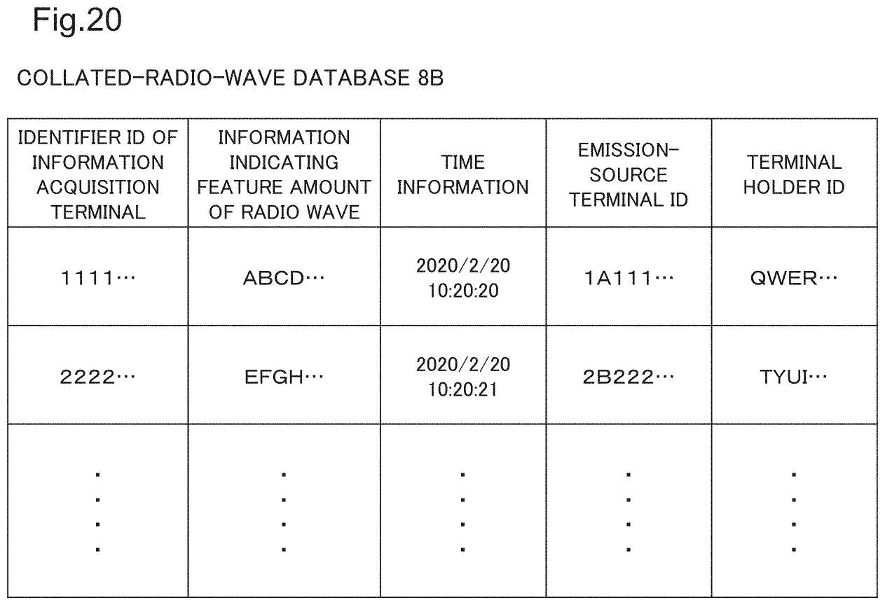

A structure of data included in the collated-radio-wave database 8B will be described by using FIG. 20. In the collated-radio-wave database 8B, information indicating a feature value of a radio wave successfully collated by the information acquisition terminal 20, an identifier ID of the information acquisition terminal 20 having acquired the radio wave, and time information are stored in association with one another. Note that an emission-source terminal ID, a terminal holder ID, and the like may be stored in association with one another.

The identification unit 14 identifies one or more pieces of time information and identifier IDs associated with the feature value of the radio wave stored in the collated-radio-wave database 8B.

The identification unit 14 then refers to the time information and the identifier ID stored in the captured-image database 3B, and identifies at least either one vehicle ID or one person ID having the same condition relating to the associated time information and the identifier ID as the feature value of the radio wave identified on the acquired-radio-wave database 2B. Similarly to the first to fourth example embodiments, the identification unit 14 sequentially refers to conditions including time information and an identifier ID, and narrows down vehicle IDs or person IDs associated with the feature value of the radio wave under a plurality of conditions. The identification unit 14 then identifies, by the narrowing, a vehicle ID or a person ID related to the feature value of the radio wave.

Note that, when the identification unit 14 refers to the time information stored in the captured-image database 3B, the identification unit 14 does not need to refer to only an identical time strictly, and it may be designed such that any time error is allowed for reference. Further, in consideration of a structure and arrangement of the information acquisition terminal 20, a condition (time information, an identifier ID, and the like) for use in association of a feature value of a radio wave with a vehicle ID may be changed according to arrangement of a radio wave reception unit 21 and an imaging unit 22, a radio-wave receivable range, an imaging section, and the like. For example, a plurality of identifier IDs for use in association may be set in consideration of arrangement of the information acquisition terminal 20, or it may be designed such that information associated with at least one of a plurality of predetermined identifier IDs is able to be referred to.

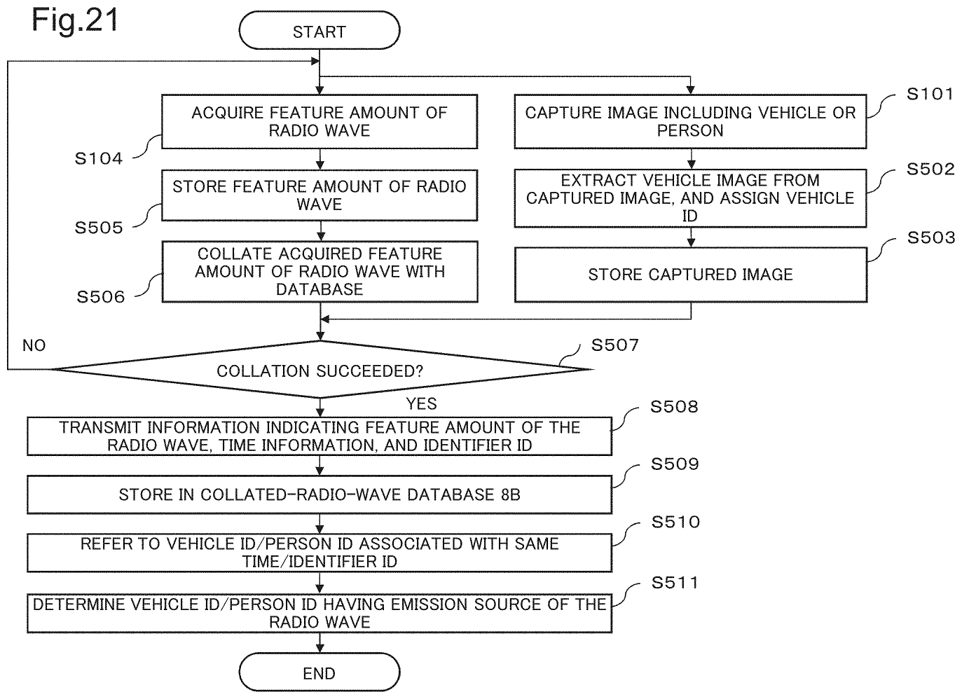

Next, flow of processing performed by the moving body tracking system 100 according to the present example embodiment will be described by using a flowchart of FIG. 21. The portions overlapping with the first to fourth example embodiments will not be described.

The second storage unit 25 included in the information acquisition terminal 20 stores data indicating the feature value of the radio wave received by the communication unit 11 (S505). Further, the second storage unit 25 stores the captured image captured by the imaging unit 22 (S503). The second collation unit 26 then collates the feature value of the radio wave stored in the second acquired-radio-wave database 6B, with a feature value of a radio wave stored in the second database for collation 5B (S506). When collation is succeeded, the terminal-side communication unit 23 transmits information indicating a feature value of a successfully-collated radio wave, time information and an identifier ID associated with the feature value of the radio wave, and captured image data captured at the same time as a reception time of the radio wave (YES in S507, and S508). The communication unit 11 receives the data transmitted from the terminal-side communication unit 23. The storage unit 13 stores the data received by the communication unit 11 (S509).

The identification unit 14 identifies one or more combinations of time information and identifier IDs associated with the feature value of the radio wave stored in the collated-radio-wave database 8B. Thereafter, the identification unit 14 refers to the captured-image database 3B, and refers to a vehicle ID or a person ID associated with the same information as the time information and the identifier ID (S510). Thereafter, the identification unit 14 sequentially refers to vehicle IDs or person IDs associated with the time information and the identifier ID, and narrows down vehicle IDs or person IDs associated with the feature value of the radio wave under a plurality of conditions. As a result of reference, the identification unit 14 identifies at least either one vehicle or one person being an emission source of the radio wave (S511). Note that the process in which the identification unit 14 identifies a vehicle or a person being an emission source is similar to the first example embodiment.

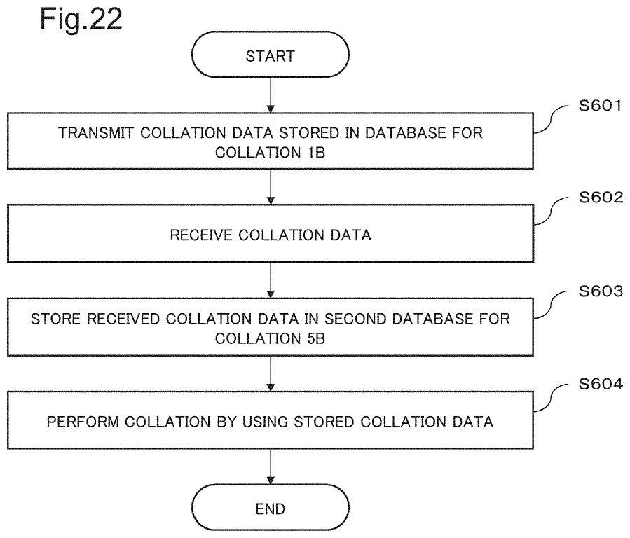

Next, flow of processing in which the moving body tracking system 100 according to the present example embodiment updates the information stored in the second database for collation 5B to be referred when collation of a feature value of a radio wave is performed by the information acquisition terminal 20 will be described by using a flowchart of FIG. 22.

The communication unit 11 transmits collation data included in the database for collation 1B (S601). The terminal-side communication unit 23 receives the collation data transmitted by the communication unit 11 (S602). The second database for collation 5B included in the second storage unit 25 stores the collation data received by the terminal-side communication unit 23 (S603). The second collation unit 26 collates the collation data stored in the second database for collation 5B with a feature value of a radio wave stored in the second acquired-radio-wave database 6B (S604).

The moving body tracking system 100 according to the present example embodiment described above is able to more accurately identify a moving body that has an emission source of a radio wave having a feature value preliminarily registered in a database, even when there are a plurality of moving bodies sending radio waves. Further, the moving body tracking system 100 according to the present example embodiment transmits only information relating to a feature value of a radio wave concerned at a time of collation, by performing collation of a feature value in the information acquisition terminal 20, which makes it possible to reduce a communication load at a time of network transmission. Further, the moving body tracking system 100 according to the present example embodiment transmits alternative information for a feature value rather than the feature value itself, which makes it possible to reduce a communication load at a time of network transmission. Accordingly, processing efficiency of the overall system is improved.

### Sixth Example Embodiment

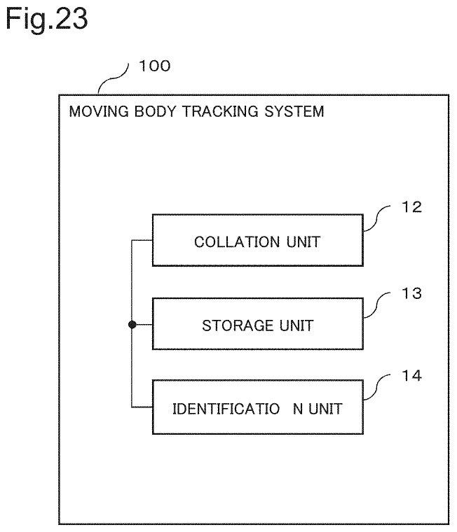

A sixth example embodiment of the present invention will be described. FIG. 23 is a function block diagram illustrating a moving body tracking system 100 according to the sixth example embodiment. The moving body tracking system 100 includes a collation unit 12, a storage unit 13, and an identification unit 14. The collation unit 12 collates a feature value for collation preliminarily stored in the storage unit 13, with a feature value of a radio wave to be collated. The storage unit 13 stores meta-information (time information, an identifier ID, and the like) associated with the feature value of the radio wave to be collated and a captured image, and a feature value for collation. The identification unit 14 refers to, from among pieces of information stored in the storage unit 13, a captured image having the same meta-information with a feature value of a successfully collated radio wave, and identifies a captured image indicating a moving body having an emission source of the radio wave. Note that the collation unit 12 and the storage unit 13 may be external to the moving body tracking system 100.

With the above configuration, the moving body tracking system 100 that identifies a moving body being an emission source of a radio wave is provided.

### Modification Examples

The present invention is not limited to the above-described example embodiments, and design changes can be made as appropriate within the scope not departing from the gist of the present invention. Modification examples applicable to the above-described first to sixth example embodiments will be described.

A modification example applicable to the above-described first to sixth example embodiments will be described. The storage unit 13, which is included in the processing device 10 according to each of the above-described example embodiments, may be mounted on an external terminal different from the processing device 10. In this case, the processing device 10 and the storage unit 13 are communicable with each other via a communication network such as the Internet. Further, some of the databases included in the storage unit 13 according to each of the above-described example embodiments may be stored in an unillustrated external storage.

Another modification example will be described. The moving body tracking system 100 functions even when there is a single information acquisition terminal 20 installed on a road. In this case, the processing device 10 identifies a captured image indicating a moving body being an emission source of a target radio wave, on the basis of time information from a set of feature values of radio waves and captured images acquired from the one information acquisition terminal 20.

Still another modification example will be described. The information acquisition terminal 20 may be communicable with a plurality of processing devices 10. Further, the radio wave reception unit 21 and the imaging unit 22 may be included in different information acquisition terminals 20. In this case, the radio wave reception unit 21 and the imaging unit 22 are communicable with each other.

Even in these cases, an advantageous effect similar to the above-described example embodiments can be acquired.

Yet still another modification example will be described. According to the present invention, the information acquisition terminal 20 may acquire IP address information on equipment instead of a feature value of a radio wave. In this case, according to each of the above-described example embodiments, the identification unit 14 identifies a moving body being an emission source, by using an IP address information instead of a feature value of a radio wave.

The above-described modification examples can be combined as appropriate with the first to sixth example embodiments, and, besides, the modification examples can be combined with one another. The configurations described in the first to sixth example embodiments may be combined with one another.

For example, in the case of combining the first to fourth example embodiments, it may be designed such that a moving body is identified by using a positive list approach within a predetermined area and a negative list approach outside the area.

For example, in the case of combining the second and fourth example embodiments, when a radio wave unknown by a database is received by using a negative list approach, a feature value of the unknown radio wave may be registered in a watchlist.

Besides the above, the components according to the above-described example embodiments can be replaced with well-known components as appropriate, within the scope not departing from the gist of the present invention. Further, the technical contents of the invention are not limited to the above-described example embodiments, and various changes can be applied within the scope not departing from the gist of the present invention.

Some or all of the above-described example embodiments and the modification examples may be described as the following supplementary notes, but are not limited to the following.

(Supplementary Note 1)

A moving body tracking system including:

a memory that stores a set of instructions; and

at least one processor configured to execute the set of instructions to identify, when a feature value of a radio wave received by a terminal is registered in a database, a moving body sending the radio wave, based on a plurality of images captured by the terminal and associated with the feature value of the radio wave.

(Supplementary Note 2)

The moving body tracking system according to Supplementary note 1, wherein

the memory stores the feature value of the radio wave received by the terminal and the image captured by the terminal in association with each other, and

the processor registers, out of the radio waves sent from the moving body, the feature value of the radio wave whose feature value is unregistered in the database, and the feature value of the radio wave whose feature value is preliminarily registered in the database, in a watchlist in association with each other.

(Supplementary Note 3)

The moving body tracking system according to Supplementary note 1, wherein the processor collates the feature value of the radio wave received by the terminal with the feature value registered in the database.

(Supplementary Note 4)

The moving body tracking system according to Supplementary note 1, wherein the processor notifies information on the moving body being identified.

(Supplementary Note 5)

The moving body tracking system according to Supplementary note 1, wherein the image includes a vehicle image, and the moving body includes a vehicle.

(Supplementary Note 6)

The moving body tracking system according to Supplementary note 5, wherein the processor notifies number plate information extracted from the image.

(Supplementary Note 7)

The moving body tracking system according to Supplementary note 1, wherein the image includes a face image or a person image, and the moving body includes a person.

(Supplementary Note 8)

The moving body tracking system according to Supplementary note 1, wherein the feature value of the radio wave is physical-layer information.

(Supplementary Note 9)

A moving body tracking system including:

a memory that stores a set of instructions; and

at least one processor configured to execute the set of instructions to identify, when a feature value of a radio wave received by a terminal is unregistered in a database, a moving body sending the radio wave, based on a plurality of images captured by the terminal and associated with the feature value of the radio wave.

(Supplementary Note 10)

The moving body tracking system according to Supplementary note 1, wherein the feature value of the radio wave is acquired by a plurality of the terminals.

(Supplementary Note 11)

A moving body tracking method including:

by an information processing device, identifying, when a feature value of a radio wave received by a terminal is registered in a database, a moving body sending the radio wave, based on a plurality of images captured by the terminal and associated with the feature value of the radio wave.

(Supplementary Note 12)

A moving body tracking method including:

by an information processing device,

identifying, when a feature value of a radio wave received by a terminal is unregistered in a database, a moving body sending the radio wave, based on a plurality of images captured by the terminal and associated with the feature value of the radio wave.

(Supplementary Note 13)

Anon-volatile computer-readable recording medium that stores a program causing a computer to execute

processing of identifying, when a feature value of a radio wave received by a terminal is registered in a database, a moving body sending the radio wave, based on a plurality of images captured by the terminal and associated with the feature value of the radio wave.

(Supplementary Note 14)

A non-volatile computer-readable recording medium that stores a program causing a computer to execute

processing of identifying, when a feature value of a radio wave received by a terminal is unregistered in a database, a moving body sending the radio wave, based on a plurality of images captured by the terminal and associated with the feature value of the radio wave.

(Supplementary Note 15)

The moving body tracking system according to Supplementary note 1, wherein the feature value of the radio wave is based on a modulation analysis of the radio wave or a temporal waveform of the radio wave.

(Supplementary Note 16)

The moving body tracking system according to Supplementary note 1, wherein the feature value of the radio wave is based on error vector magnitude, or a temporal waveform (waveform analysis) of a radio wave.

(Supplementary Note 17)

The moving body tracking system according to Supplementary note 1, wherein

the processor performs notification, when the radio wave having the feature value unregistered in the database is received, and

the terminal receives the radio wave sent from a particular area.

(Supplementary Note 18)

The moving body tracking system according to Supplementary note 1, wherein the terminal acquires the radio wave and the image being captured at a plurality of times.

(Supplementary Note 19)

The moving body tracking system according to Supplementary note 1, wherein

the memory stores meta-information associated with the feature value of the radio wave to be collated and the image captured, and the feature value for collation;

the processor collates the feature value for collation preliminarily stored in the memory, with the feature value of the radio wave to be collated, and refers to, from among pieces of information stored in the memory, the captured image having same meta-information with the feature value of a successfully collated radio wave, and identifies a captured image indicating the moving body having an emission source of the radio wave.

### REFERENCE SIGNS LIST

1A Processor
2A Memory
3A Input/output interface
4A Peripheral circuit
5A Communication interface
6A Bus
1B Database for collation
2B Acquired-radio-wave database
3B Captured-image database
4B Watchlist
5B Second database for collation
6B Second acquired-radio-wave database
7B Second captured-image database
8B Collated-radio-wave database
100 Moving body tracking system
10 Processing device
11 Communication unit
12 Collation unit
13 Storage unit
14 Identification unit
15 Output unit
16 Second identification unit
17 Watchlist registration unit
18 Watchlist notification unit
19 Image processing unit
20 Information acquisition terminal
21 Radio wave reception unit
22 Imaging unit
23 Terminal-side communication unit
24 Code assignment unit
25 Second storage unit
26 Second collation unit

1. A moving body tracking system comprising:
a memory that stores a set of instructions; and
at least one processor configured to execute the set of instructions to identify, when a feature value of a radio wave received by a terminal is registered in a database, a moving body sending the radio wave, based on a plurality of images captured by the terminal and associated with the feature value of the radio wave.

2. The moving body tracking system according to claim 1, wherein
the memory stores the feature value of the radio wave received by the terminal and the image captured by the terminal in association with each other, and
the processor registers, out of the radio waves sent from the moving body, the feature value of the radio wave whose feature value is unregistered in the database, and the feature value of the radio wave whose feature value is preliminarily registered in the database, in a watchlist in association with each other.

3. The moving body tracking system according to claim 1, wherein the processor collates the feature value of the radio wave received by the terminal with the feature value registered in the database.

4. The moving body tracking system according to claim 1, wherein the processor notifies information on the moving body being identified.

5. The moving body tracking system according to claim 1, wherein the image includes a vehicle image, and the moving body includes a vehicle.

6. The moving body tracking system according to claim 5, wherein the processor notifies number plate information extracted from the image.

7. The moving body tracking system according to claim 1, wherein the image includes a face image or a person image, and the moving body includes a person.

8. The moving body tracking system according to claim 1, wherein the feature value of the radio wave is physical-layer information.

9. A moving body tracking system comprising:
a memory that stores a set of instructions; and
at least one processor configured to execute the set of instructions to identify, when a feature value of a radio wave received by a terminal is unregistered in a database, a moving body sending the radio wave, based on a plurality of images captured by the terminal and associated with the feature value of the radio wave.

10. The moving body tracking system according to claim 1, wherein the feature value of the radio wave is acquired by a plurality of the terminals.

11. A moving body tracking method comprising:
by an information processing device,
identifying, when a feature value of a radio wave received by a terminal is registered in a database, a moving body sending the radio wave, based on a plurality of images captured by the terminal and associated with the feature value of the radio wave.

12. A moving body tracking method comprising:
by an information processing device,
identifying, when a feature value of a radio wave received by a terminal is unregistered in a database, a moving body sending the radio wave, based on a plurality of images captured by the terminal and associated with the feature value of the radio wave.

13. A non-volatile computer-readable recording medium that stores a program causing a computer to execute
processing of identifying, when a feature value of a radio wave received by a terminal is registered in a database, a moving body sending the radio wave, based on a plurality of images captured by the terminal and associated with the feature value of the radio wave.

14. A non-volatile computer-readable recording medium that stores a program causing a computer to execute
processing of identifying, when a feature value of a radio wave received by a terminal is unregistered in a database, a moving body sending the radio wave, based on a plurality of images captured by the terminal and associated with the feature value of the radio wave.

15. The moving body tracking system according to claim 1, wherein the feature value of the radio wave is based on a modulation analysis of the radio wave or a temporal waveform of the radio wave.

16. The moving body tracking system according to claim 1, wherein the feature value of the radio wave is based on error vector magnitude, or a temporal waveform (waveform analysis) of a radio wave.

17. The moving body tracking system according to claim 1, wherein
the processor performs notification, when the radio wave having the feature value unregistered in the database is received, and
the terminal receives the radio wave sent from a particular area.

18. The moving body tracking system according to claim 1, wherein the terminal acquires the radio wave and the image being captured at a plurality of times.

19. The moving body tracking system according to claim 1, wherein
the memory stores meta-information associated with the feature value of the radio wave to be collated and the image captured, and the feature value for collation;
the processor collates the feature value for collation preliminarily stored in the memory, with the feature value of the radio wave to be collated, and refers to, from among pieces of information stored in the memory, the captured image having same meta-information with the feature value of a successfully collated radio wave, and identifies a captured image indicating the moving body having an emission source of the radio wave.
